(19) United States
(12) Patent Application Publication
(10) Pub. No.: US 2026/0029941 A1
(43) Pub. Date: Jan. 29, 2026

(54) SPARE BLOCK POOL MANAGEMENT IN STORAGE DEVICES

(71) Applicant: Sandisk Technologies, Inc., Milpitas, CA (US)

(72) Inventors: NAGI REDDY CHODEM, Bangalore (IN); CHAITANYA KAVIRAYANI, Bangalore (IN); GURSIMRAN KASHYAP, Bangalore (IN)

(73) Assignee: Sandisk Technologies, Inc., Milpitas, CA (US)

(21) Appl. No.: 18/780,782

(22) Filed: Jul. 23, 2024

(51) Int. Cl. G06F 3/06

(52) U.S. Cl. CPC G06F 3/064; G06F 3/0604; G06F 3/0631; G06F 3/0679

(57) ABSTRACT

A storage device may manage free super blocks when a number of empty super blocks is at a critical level. The storage device includes a memory including multiple dies divided into physical blocks. A controller on the storage device may form super blocks from the physical blocks. The controller may store information for empty super blocks in a free pool. When the storage device is initialized and the controller receives a host write request, the controller may determine that a number of empty super blocks in the free pool is less than a warning threshold. The controller may obtain a first super block from the free pool, divide the first super block into a set of sub-super blocks, and allocate one of the sub-super blocks for the host write request, enabling the device to handle more power/program failures when the device is at or close to a critical threshold.

### BACKGROUND OF THE INVENTION

A storage device may be communicatively coupled to a host and to non-volatile memory including, for example, a NAND flash memory device on which the storage device may store data received from the host. The memory device may include multiple dies which may be divided into physical blocks. Physical blocks from multiple dies may also be configured to form a super block. i.e., a logical block which may be composed of physical blocks from all the dies and channels in the memory device to extract higher throughput for parallel reads and writes.

A controller on the storage device may process background operations, including garbage collection, to manage the resources on the storage device. In managing the resources of the storage device, the controller may recycle the super blocks (i.e., move data from one super block to another super block) to optimize how space on the memory device is used and improve efficiency. In moving data around on the memory device, a write amplification factor (WAF), i.e., a value representing the amount of data the controller writes relative to the amount of data submitted by the host, may increase.

The storage device may add all free/empty super blocks to a spare/free pool, wherein when the storage device receives a host/client write request or a controller write request, the storage device may retrieve a super block from the spare pool and write the data associated with the write request to the retrieved super block. The storage device may include predefined thresholds and when the number of free super blocks in the spare pool falls below a given threshold, the storage device may perform a corresponding operation for that threshold. For example, the storage device may include a critical threshold, a recycle threshold, and a steady-state threshold.

The critical threshold may be the minimum number of free super blocks that may be required to tolerate program and/or power failures. The recycle threshold may indicate the number of free super blocks that may be buffered to perform recycling operations (for example, garbage collection) at different rates. The steady-state threshold may be used to determine the approximate number of free super blocks that may be kept in the spare pool for random workloads and this number of free super blocks may not be used for any other purpose in a normal scenario. In one example, the critical threshold may be set at seven free super blocks, the recycle threshold may be set at ten to eighteen free super blocks, and the steady-state threshold may be set at fourteen free super blocks. The recycling operation rate may be higher when the recycle threshold is set to, for example, ten than when the recycle threshold is set to, for example, eighteen.

Consider a case where the storage device may have eight free super blocks in the free pool and may be operating close to the critical threshold. If a power failure occurs at this point, when the storage device is powered up, the storage device may be initialized. At or after initialization, all open super blocks that were written to prior to the power failure may be closed and marked for recycling operations. After initialization if the storage device receives new host write requests, the storage device may retrieve one or more super blocks from the free pool and may write the host data to the retrieved super block(s). If the storage device experiences successive failures that may cause the storage device to be power cycled and initialized one or more times. The storage device may thus use up all the free super blocks in the spare pool and, after initialization rather than closing a super block that was opened prior to a power recycle, the storage device may have to continue writing to the open super block, potentially creating data integrity issues.

In current systems, to prevent a storage device initialized after a program/power failure from writing to a super block that was opened prior to the failure, the storage device may enter a critical reclaim state. In the critical reclaim state, the storage device may stop accepting host write commands and may only allow reclaim writes (i.e., writes associated with a recycling operation performed by the controller). This may lead to host write command timeouts and may affect the performance of the storage device.

### SUMMARY OF THE INVENTION

In some implementations, the storage device may manage free super blocks when a number of empty super blocks is at a critical level. The storage device includes a memory device including multiple dies divided into physical blocks. A controller on the storage device may form super blocks from the physical blocks on the dies. The controller may store information for empty super blocks in a free pool. When the storage device is initialized and the controller receives a host write request, the controller may determine that a number of empty super blocks in the free pool is less than a warning threshold. The controller may obtain a first super block from the free pool, divide the first super block into a set of sub-super blocks, and allocate one of the sub-super blocks for the host write request.

In some implementations, a method is provided on a storage device for managing free super blocks in a storage device when a number of empty super blocks is at a critical level. The method includes forming super blocks and storing information for empty super blocks in a free pool. The method also includes determining that the storage device is initialized, receiving a write request and identifying a source of the write request, The method further includes identifying a client write request and determining that a criterion for creating a set of sub-super blocks exists. The method also includes obtaining a first super block from the free pool, dividing the first super block into the set of sub-super blocks, and allocating one of the sub-super blocks for the client write request.

In some implementations, a method is provided for recycling free super blocks in a storage device including super blocks and sub-super blocks. The method includes determining that a recycling operation is to be performed. The method also includes selecting a first super block for recycling, determining that the first super block is not mapped to a set of sub-super blocks in a mapping table, and performing garbage collection on the first super block. The method further includes selecting a second super block for recycling, determining that the second super block is mapped to the set of sub-super blocks in the mapping table, performing garbage collection on the set of sub-super blocks, and reuniting the set of sub-super blocks to reform the second super block.

### BRIEF DESCRIPTION OF THE DRAWINGS

FIG. 1 is a schematic block diagram of an example system in accordance with some implementations.

FIG. 2 is an example block diagram of lists with identifiers for super blocks and sub-super blocks used by a storage device in accordance with some implementations.

FIG. 3 is an example block diagram of a mapping table used in accordance with some implementations.

FIG. 4 is an example flow diagram for handling host write requests when the number of free super blocks is at or below a warning threshold in accordance with some implementations.

FIG. 5 is an example flow diagram for how the storage device performs recycling operations in an environment with super blocks and sub-super blocks in accordance with some implementations.

FIG. 6 is a diagram of an example environment in which systems and/or methods described herein are implemented.

FIG. 7 is a diagram of example components of one or more devices of FIG. 1.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of implementations of the present disclosure.

The apparatus and method components have been represented where appropriate by conventional symbols in the drawings, showing those specific details that are pertinent to understanding the implementations of the present disclosure so as not to obscure the disclosure with details that will be readily apparent to those of ordinary skill in the art.

### DETAILED DESCRIPTION OF THE INVENTION

The following detailed description of example implementations refers to the accompanying drawings. The same reference numbers in different drawings may identify the same or similar elements.

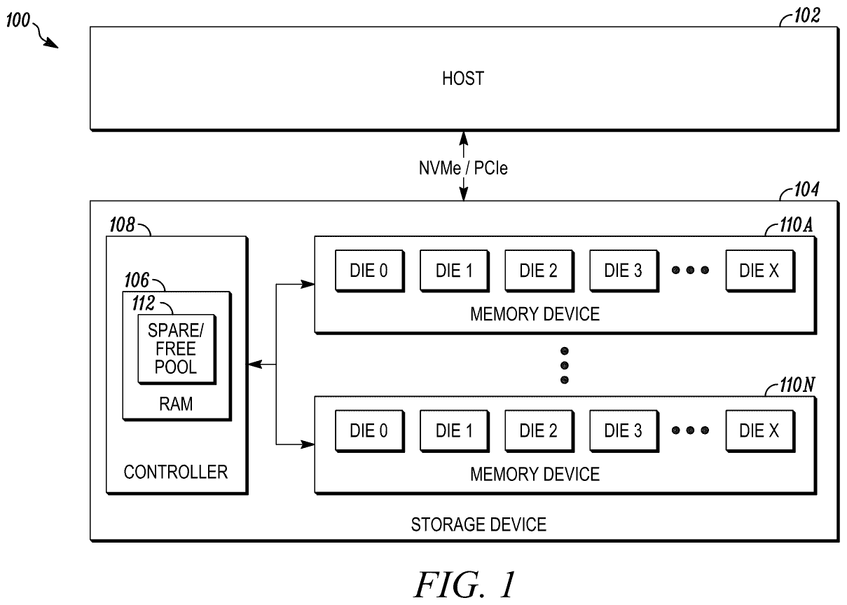

FIG. 1 is a schematic block diagram of an example system in accordance with some implementations. System 100 includes a host 102 and a storage device 104 that may be in the same physical location as components on a single computing device or on different computing devices that are communicatively coupled. Storage device 104, in various embodiments, may be disposed in one or more different locations relative to the host 102. System 100 may include additional components (not shown in this figure for the sake of simplicity).

Storage device 104 may include a random-access memory (RAM) 106, a controller 108, and one or more non-volatile memory devices 110a-110n (referred to herein as the memory device(s) 110). Storage device 104 may be, for example, a solid-state drive (SSD). RAM 106 may be static RAM (SRAM) or a dynamic RAM (DRAM) that may be used to store information used on storage device 104. Controller 108 may interface with host 102 and process foreground operations including instructions transmitted from host 102. For example, controller 108 may read data from and/or write to memory device 110 based on instructions received from host 102. Controller 108 may also execute background operations to manage resources on memory device 110. For example, controller 108 may monitor memory device 110 and may execute garbage collection and other relocation functions per internal relocation algorithms to refresh, recycle, and/or relocate the data on memory device 110.

Memory device 110 may be flash based. For example, memory device 110 may be a NAND or NOR flash memory that may be used for storing host and control data over the operational life of memory device 110. Memory device 110 may include multiple dies (for example, DIE 0-DIE X) for storing the data. Data may be stored in blocks on the dies in various formats, with the formats being defined by the number of bits that may be stored per memory cell. Memory device 110 may be included in storage device 104 or may be otherwise communicatively coupled to storage device 104.

To extract higher throughput for parallel reads and writes, physical blocks from multiple dies may be configured to form a super block. i.e., a logical block which may be composed of physical blocks from all the dies and channels in memory device 110. For example, a super block may include a block from each of DIES 0-X in memory device 110A. RAM 106 may include a spare/free pool 112 for storing information associated with free/empty super blocks and storage device 104 may compare predefined thresholds with the number of free super blocks in spare pool 112. For example, storage device 104 may compare a critical threshold, a recycle threshold, a steady-state threshold, and a warning threshold with the number of free super blocks in spare pool 112.

The critical threshold may indicate the required minimum number of free super blocks in spare pool 112 to tolerate program and/or power failures. The recycle threshold may indicate the number of free super blocks in spare pool 112 that may be buffered to perform recycling operations at different rates. The steady-state threshold may indicate the number of free super blocks to be kept in spare pool 112 for random workloads. The warning threshold may indicate when the number of free super blocks in spare pool 112 is at or close to the critical threshold. The warning threshold may be less than the steady-state threshold and/or the recycle threshold.

In a situation where the number of free super blocks in spare pool 112 is equal to or less than the warning threshold, when storage device 104 is initialized, storage device 104 may divide one or more free super blocks in spare pool 112 into sets of smaller super blocks (referred to herein as sub-super blocks). For example, storage device 104 may divide a thirty-two-die super block into four eight-die sub-super blocks, or a sixty-four-die super block into eight eight-die sub-super blocks. As such, when storage device 104 is initialized after a failure and is close to the critical threshold, instead of having one thirty-two-die super block for host writes, storage device 104 may have four eight-die sub-super blocks.

RAM 106 may include a formed super block list and an unformed super block list. The formed super block list may include a first list of super block identifiers (SBUID), each of which may be associated with a super block, and the unformed super block list may include a second list of super block identifiers, each of which may be associated with a super block that is to be divided into sub-super blocks. Storage device 104 may also include a formed sub-super block list and an unformed sub-super block list. The formed sub-super block list may include a list of sub-super block identifiers, each of which may be associated with a formed sub-super block (i.e., a sub-super block that is created when the number of free super blocks is at or below the warning threshold after initialization of storage device 104). The unformed sub-super block list may include a list of sub-super block identifiers, each of which may be associated with an unformed sub-super block (i.e., a sub-super block that may be created when the number of free super blocks is at or below the warning threshold after initialization of storage device 104). In some cases, the unformed sub-super block list may include a predefined maximum number of sub-super blocks identifiers, thus limiting the number of sub-super blocks that may be created.

RAM 106 may also include a mapping table to associate a super block that is divided into a set of sub-super blocks with the set of sub-super blocks. The sub-super blocks in a set may have consecutive identifiers and, in the mapping table, the super block identifier may be mapped to the sub-super block identifier for the first sub-super block in the set. Each entry in the mapping table may include the total valid page count (VPC) of all sub-super blocks in a set. Based on the valid page count of the sub-super blocks in a set, a sparse pool index may be updated. The sparse pool index may be used to indicate that a sub-super block is valid and may be used to identify sub-super blocks during a recycling operation. The identifier for a super block which is mapped to a set of sub-super blocks may also be added to a sparse pool, wherein placement of a super block identifier in the sparse pool may cause the super block to be selected during a recycling operation.

Consider an example where the critical threshold is set at seven, the recycle threshold is set at ten to eighteen free super blocks, the steady-state threshold is set at fourteen, and the warning threshold is set at eight. When storage device 104 is initialized after a power failure, storage device 104 may close the super blocks that were open for host writes prior to the power failure. When storage device 104 receives a host write command, storage device 104 may determine if the number of super blocks in free pool 112 is less than or equal to the warning threshold and if a number of formed sub-super blocks is less than a maximum number of allowed sub-super blocks. If both conditions are satisfied, storage device 104 may move the identifiers for one or more super blocks from the formed super block list to the unformed super block list. Storage device 104 may divide the super block associated with the identifier in the unformed super block list into a set of sub-super blocks and move the identifiers associated with the set of sub-super blocks from the unformed sub-super block list to the formed sub-super block list. Storage device 104 may increment a sub-super block counter and allocate a formed sub-super block for the host write. If successive power/program failures occur when storage device 104 allocates one or more sub-super blocks for host writes, storage device 104 may close the allocated sub-super blocks after initialization, which may be less costly than closing a full super block. As such, storage device 104 may be able to handle a greater number of power/program failures when storage device 104 is at or close to the critical threshold.

To reduce the number of free super blocks that may be associated with the thresholds when storage device 104 divides a super block, storage device 104 may reduce the values of the thresholds simultaneously with a dynamic super block division. By reducing the thresholds, storage device 104 may reserve a smaller number of super blocks in free pool 112 and release the remaining super blocks for host writes. For example, during a super block division, the critical threshold may be reduced from seven to three free super blocks, the recycle threshold may be reduced from ten to eighteen free super blocks to five to eleven free super blocks, the steady-state threshold may be reduced from fourteen free super blocks to eight free super blocks, and the warning threshold may be reduced from eight free super blocks to four free super blocks.

Storage device 104 may perform these processes based on a processor, for example, controller 108 executing software instructions stored by a non-transitory computer-readable medium, such as storage component 110. As used herein, the term “computer-readable medium” refers to a non-transitory memory device. Software instructions may be read into storage component 110 from another computer-readable medium or from another device. When executed, software instructions stored in storage component 110 may cause controller 108 to perform one or more processes described herein. Additionally, or alternatively, hardware circuitry may be used in place of or in combination with software instructions to perform one or more processes described herein. Thus, implementations described herein are not limited to any specific combination of hardware circuitry and software. System 100 may include additional components (not shown in this figure for the sake of simplicity). FIG. 1 is provided as an example. Other examples may differ from what is described in FIG. 1.

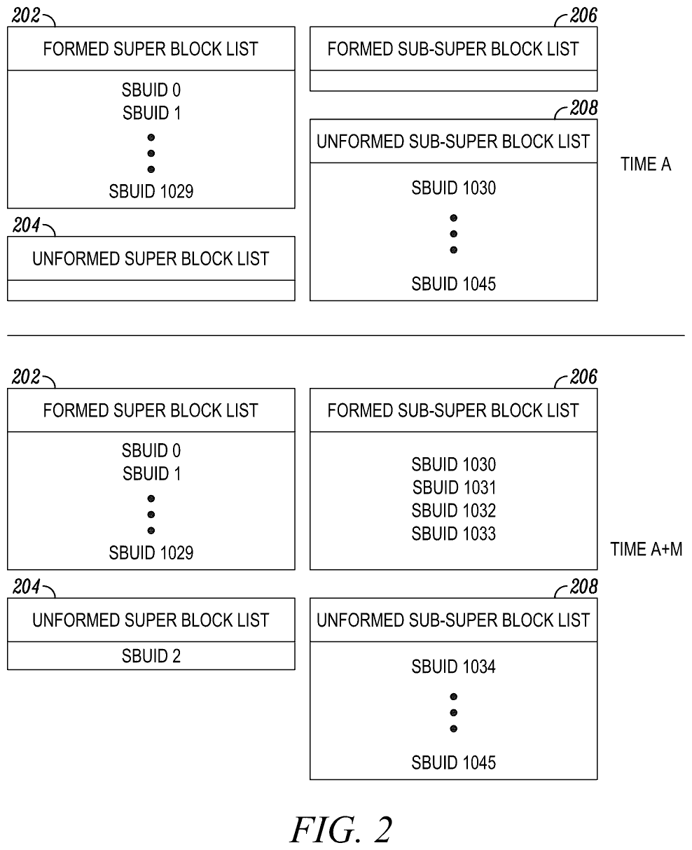

FIG. 2 is an example block diagram of lists with identifiers for super blocks and sub-super blocks used by the storage device in accordance with some implementations. The lists may include a formed super block list 202, an unformed super block list 204, a formed sub-super block list 206, and an unformed sub-super block list 208, each of which may be stored in RAM 106. Formed super block list 202 may include the super block identifiers (SBUID) for the super blocks used by storage device 104. Unformed super block list 204 may include the SBUIDs for super blocks that are to be divided into sub-super blocks. Formed sub-super block list 206 may include a list of SBUIDs for formed sub-super blocks (i.e., sub-super blocks created when the number of free super blocks is at or below the warning threshold after initializing storage device 104). Unformed sub-super block list 208 may include a list of SBUIDs associated with unformed sub-super blocks (i.e., sub-super blocks that may be created when the number of free super blocks is at or below the warning threshold after initializing storage device 104). In some cases, unformed sub-super block list 208 may include a predefined maximum number of SBUIDs, thus limiting the number of sub-super blocks that may be created.

Consider, for example, that memory device 110 includes 1030 super blocks, i.e., super blocks 0-1029. Formed super block list 202 may include the super block identifiers (SBUID) for super blocks 0-1029. At an initial stage (shown as TIME A) when the number of free super blocks in free pool 112 is greater than the critical threshold, the recycle threshold, the steady-state threshold, and the warning threshold, unformed super block list 204 may be empty. Formed sub-super block list 206 may also be empty. Unformed sub-super block list 208 may include a list of SBUIDs, each of which may be associated with an unformed sub-super block.

At TIME A+M, when the number of free super blocks in free pool 112 is equal to or less than the warning threshold, when storage device 104 receives a host write request after it has been power cycled and initialized, controller 108 may select super block 2 to be divided into sub-super blocks and the identifier for super block 2 (SBUID 2) may be stored in unformed super block list 204. The sub-super block identifiers (SBUID 1030-1033) associated with the sub-super blocks created from super block 2 may be moved to formed sub-super block list 206. As indicated above FIG. 2 is provided as an example. Other examples may differ from what is described in FIG. 2.

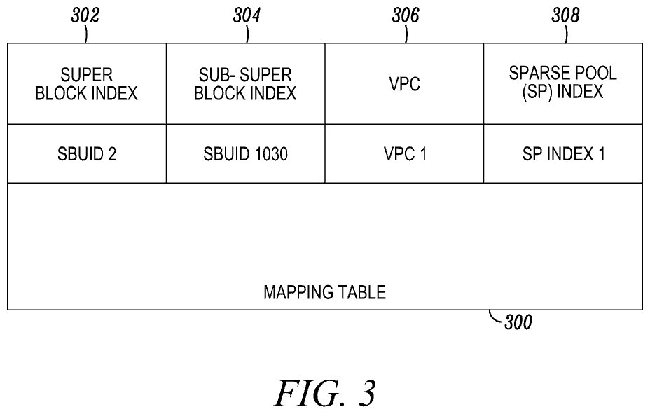

FIG. 3 is an example block diagram of a mapping table used in accordance with some implementations. Mapping table 300 may include a super block index 302, a sub-super block index 304, a valid page count (VPC) 306, and a sparse pool index 308. Super block index 302 may include the identifier of a super block that was divided into a set of sub-super blocks having consecutive identifiers. Sub-super block index 304 may include the identifier for the first sub-super block in the set. VPC 306 may include the total valid page count of all sub-super blocks in a set. Sparse pool index 308 may be updated based on the valid page count of the sub-super blocks in a set and sparse pool index 308 may be used to indicate that a sub-super block is valid and to identify sub-super blocks during a recycling operation. When the identifier for a super block is mapped to a set of sub-super blocks in mapping table 300, the identifier for the super block may also be added to a sparse pool (not shown), wherein placement of a super block identifier in the sparse pool may cause the super block to be selected during a recycling operation.

Using the example shown in FIG. 2, for an entry in mapping table, super block index 302 will include SBUID 2, sub-super block index 304 will include SBUID 1030 (i.e., the identifier for the first sub-super block in the set), VPC 306 may include the total valid page count of all sub-super blocks in the set, and sparse pool index 308 may be updated based on the valid page count of the sub-super blocks in a set. As indicated above FIG. 3 is provided as an example. Other examples may differ from what is described in FIG. 3.

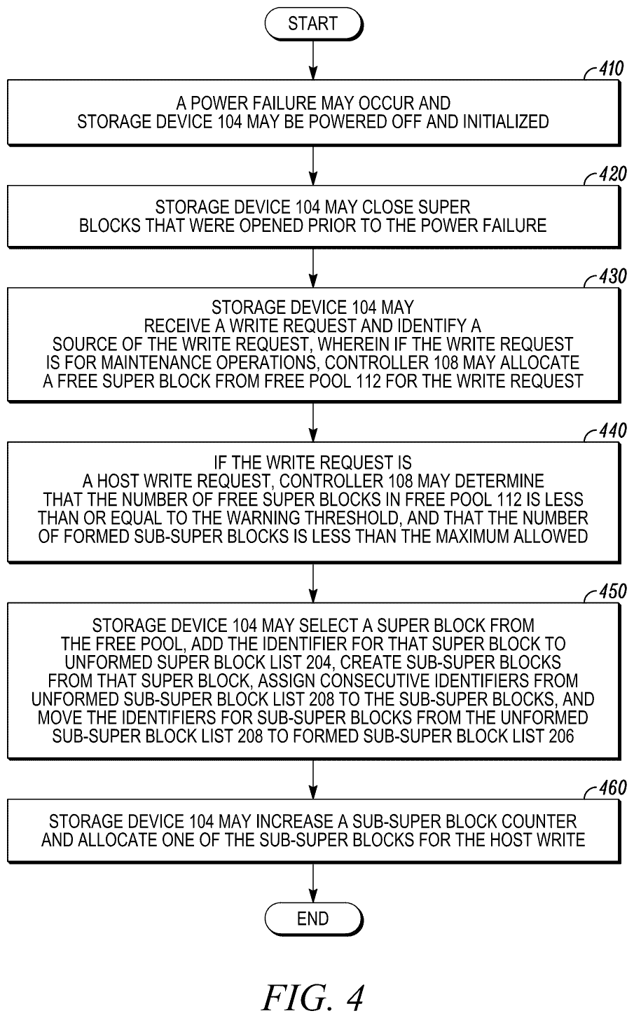

FIG. 4 is an example flow diagram for handling host write requests when the number of free super blocks is at or below the warning threshold in accordance with some implementations. At 410, a power failure may occur and storage device 104 may be powered off and initialized. At 420, storage device 104 may close super blocks that were opened prior to the power failure. At 430, storage device 104 may receive a write request and identify a source of the write request, wherein if the write request is for maintenance operations, controller 108 may allocate a free super block from free pool 112 for the write request. At 440, if the write request is a client write request, controller 108 may determine that a criterion for creating a set of sub-super blocks exists. For example, controller 108 may determine that the number of free super blocks in free pool 112 is less than or equal to the warning threshold and that the number of formed sub-super blocks is less than the maximum allowed. At 450, storage device 104 may select a super block from the free pool, add the identifier for that super block to unformed super block list 204, create a set of sub-super blocks from that super block, assign consecutive identifiers from unformed sub-super block list 208 to the sub-super blocks, and move the identifiers for sub-super blocks from the unformed sub-super block list 208 to formed sub-super block list 206. At 460, storage device 104 may increase a sub-super block counter and allocate one of the sub-super blocks for the host write. As indicated above FIG. 4 is provided as an example. Other examples may differ from what is described in FIG. 4.

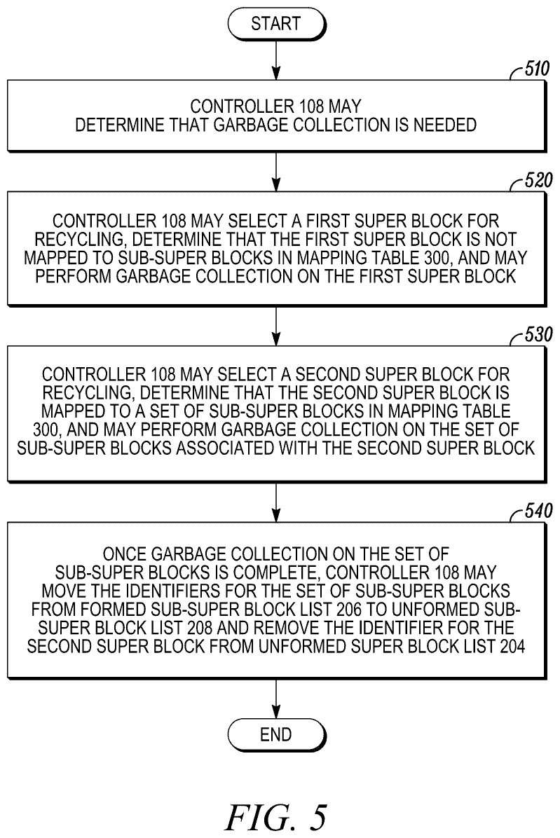

FIG. 5 is an example flow diagram for how the storage device performs recycling operations in an environment with super blocks and sub-super blocks in accordance with some implementations. At 510, controller 108 may determine that garbage collection is needed. At 520, controller 108 may select a first super block for recycling, determine that the first super block is not mapped to sub-super blocks in mapping table 300, and may perform garbage collection on the first super block. At 530, controller 108 may select a second super block for recycling, determine that the second super block is mapped to a set of sub-super blocks in mapping table 300, and may perform garbage collection on the set of sub-super blocks associated with the second super block. At 540, once garbage collection on the set of sub-super blocks is complete, controller 108 may reunite the set of sub-super blocks to reform the second super block by, for example, moving the identifiers for the set of sub-super blocks from formed sub-super block list 206 to unformed sub-super block list 208, and removing the identifier for the second super block from unformed super block list 204. As indicated above FIG. 5 is provided as an example. Other examples may differ from what is described in FIG. 5.

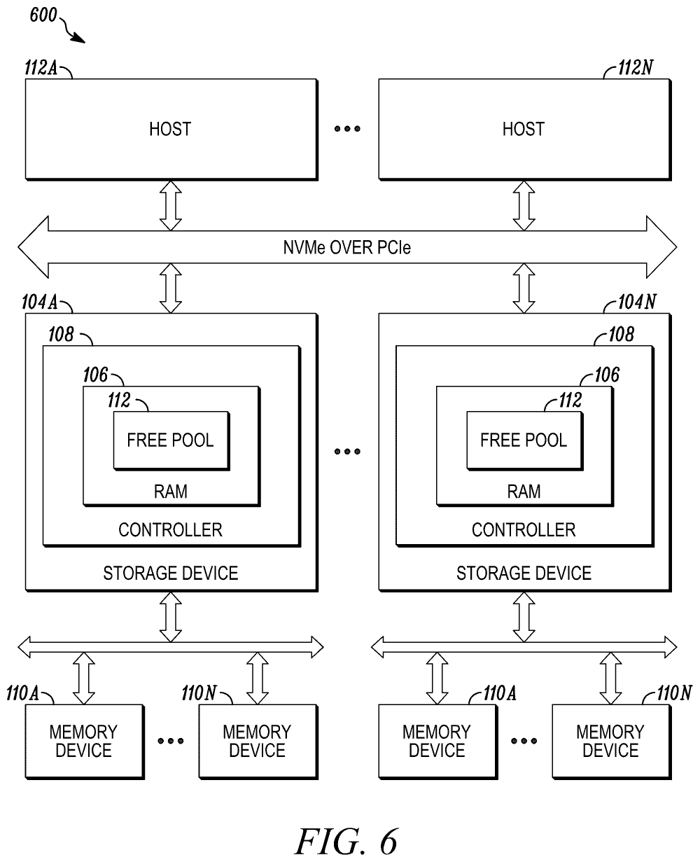

FIG. 6 is a diagram of an example environment in which systems and/or methods described herein are implemented. As shown in FIG. 6, Environment 600 may include hosts 102-102n (referred to herein as host(s) 102), and one or more storage devices 104a-104n (referred to herein as storage device(s) 104). Storage device 104 may include a controller 108 to divide a super block into sub-super blocks when the number for super blocks in free pool 112 is less than or equal to the warning threshold. Hosts 102 and storage devices 104 may communicate via Non-Volatile Memory Express (NVMe) over peripheral component interconnect express (PCI Express or PCIe), SD, or the like.

Devices of Environment 600 may interconnect via wired connections, wireless connections, or a combination of wired and wireless connections. For example, the network in FIG. 6 may include NVMe over Fabric (NVMe-oF) Internet Small Computer Systems Interface (iSCSI), Fibre Channel (FC), Fibre Channel Over Ethernet (FCOE) connectivity and any another type of next-generation network and storage protocols, a local area network (LAN), a wide area network (WAN), a metropolitan area network (MAN), a private network, an ad hoc network, an intranet, the Internet, a fiber optic-based network, a cloud computing network, or the like, and/or a combination of these or other types of networks.

The number and arrangement of devices and networks shown in FIG. 6 are provided as an example. In practice, there may be additional devices and/or networks, fewer devices and/or networks, different devices and/or networks, or differently arranged devices and/or networks than those shown in FIG. 6. Furthermore, two or more devices shown in FIG. 6 may be implemented within a single device, or a single device shown in FIG. 6 may be implemented as multiple, distributed devices. Additionally, or alternatively, a set of devices (e.g., one or more devices) of Environment 600 may perform one or more functions described as being performed by another set of devices of Environment 600.

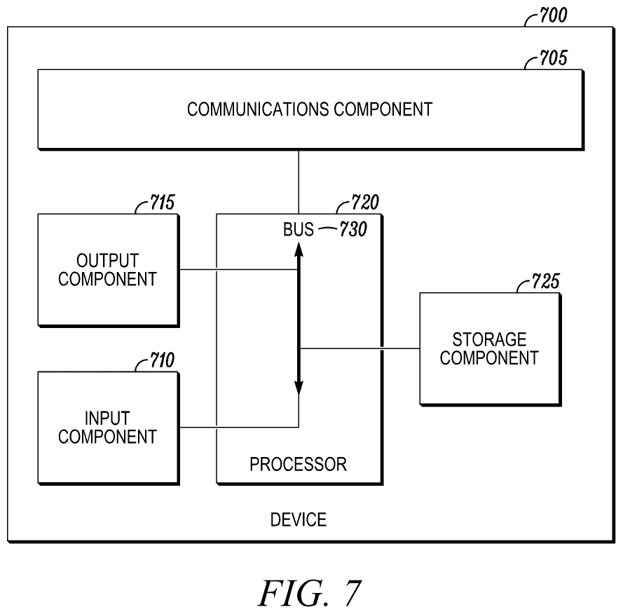

FIG. 7 is a diagram of example components of one or more devices of FIG. 1. In some implementations, host 102 may include one or more devices 700 and/or one or more components of device 700. Device 700 may include, for example, a communications component 705, an input component 710, an output component 715, a processor 720, a storage component 725, and a bus 730. Bus 730 may include components that enable communication among multiple components of device 700, wherein components of device 700 may be coupled to be in communication with other components of device 700 via bus 730.

Input component 710 may include components that permit device 700 to receive information via user input (e.g., keypad, a keyboard, a mouse, a pointing device, and a network/data connection port, or the like), and/or components that permit device 700 to determine the location or other sensor information (e.g., an accelerometer, a gyroscope, an actuator, another type of positional or environmental sensor). Output component 715 may include components that provide output information from device 700 (e.g., a speaker, display screen, and network/data connection port, or the like). Input component 710 and output component 715 may also be coupled to be in communication with processor 720.

Processor 720 may be a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, processor 720 may include one or more processors capable of being programmed to perform a function. Processor 720 may be implemented in hardware, firmware, and/or a combination of hardware and software.

Storage component 725 may include one or more memory devices, such as random-access memory (RAM 106), read-only memory (ROM), and/or another type of dynamic or static storage device (e.g., a flash memory, a magnetic memory, and/or optical memory) that stores information and/or instructions for use by processor 720. A memory device may include memory space within a single physical storage device or memory space spread across multiple physical storage devices. Storage component 725 may also store information and/or software related to the operation and use of device 700. For example, storage component 725 may include a hard disk (e.g., a magnetic disk, an optical disk, and/or a magneto-optic disk), a solid-state drive (SSD), a compact disc (CD), a digital versatile disc (DVD), a floppy disk, a cartridge, a magnetic tape, CXL device and/or another type of non-transitory computer-readable medium, along with a corresponding drive.

Communications component 705 may include a transceiver-like component that enables device 700 to communicate with other devices, such as via a wired connection, a wireless connection, or a combination of wired and wireless connections. The communications component 705 may permit device 700 to receive information from another device and/or provide information to another device. For example, communications component 705 may include an Ethernet interface, an optical interface, a coaxial interface, an infrared interface, a radio frequency (RF) interface, a universal serial bus (USB) interface, a Wi-Fi interface, and/or a cellular network interface that may be configurable to communicate with network components, and other user equipment within its communication range. Communications component 705 may also include one or more broadband and/or narrowband transceivers and/or other similar types of wireless transceiver configurable to communicate via a wireless network for infrastructure communications. Communications component 705 may also include one or more local area network or personal area network transceivers, such as a Wi-Fi transceiver or a Bluetooth transceiver.

Device 700 may perform one or more processes described herein. For example, device 700 may perform these processes based on processor 720 executing software instructions stored by a non-transitory computer-readable medium, such as storage component 725. As used herein, the term “computer-readable medium” refers to a non-transitory memory device. Software instructions may be read into storage component 725 from another computer-readable medium or from another device via communications component 705. When executed, software instructions stored in storage component 725 may cause processor 720 to perform one or more processes described herein. Additionally, or alternatively, hardware circuitry may be used in place of or in combination with software instructions to perform one or more processes described herein. Thus, implementations described herein are not limited to any specific combination of hardware circuitry and software.

The number and arrangement of components shown in FIG. 7 are provided as an example. In practice, device 700 may include additional components, fewer components, different components, or differently arranged components than those shown in FIG. 7. Additionally, or alternatively, a set of components (e.g., one or more components) of device 700 may perform one or more functions described as being performed by another set of components of device 700.

The foregoing disclosure provides illustrative and descriptive implementations but is not intended to be exhaustive or to limit the implementations to the precise form disclosed herein. One of ordinary skill in the art will appreciate that various modifications and changes can be made without departing from the scope of the present disclosure as set forth in the claims below. Accordingly, the specification and figures are to be regarded in an illustrative rather than a restrictive sense, and all such modifications are intended to be included within the scope of present teachings.

As used herein, the term “component” is intended to be broadly construed as hardware, firmware, and/or a combination of hardware and software. It will be apparent that systems and/or methods described herein may be implemented in different forms of hardware, firmware, and/or a combination of hardware and software.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set.

No element, act, or instruction used herein should be construed as critical or essential unless explicitly described as such. Also, as used herein, the articles “a” and “an” are intended to include one or more items and may be used interchangeably with “one or more.” Furthermore, as used herein, the term “set” is intended to include one or more items (e.g., related items, unrelated items, a combination of related items, unrelated items, and/or the like), and may be used interchangeably with “one or more.” The term “only one” or similar language is used where only one item is intended. Further, the phrase “based on” is intended to mean “based, at least in part, on” unless explicitly stated otherwise.

Moreover, in this document, relational terms such as first and second, top and bottom, and the like, may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, or “contains . . . a” does not, without more constraints, preclude the existence of additional identical elements in the process, method, article, or apparatus that comprises, has, includes, contains the element. The terms “substantially”, “essentially”, “approximately”, “about” or any other version thereof, are defined as being close to as understood by one of ordinary skill in the art, and in one non-limiting implementation, the term is defined to be within 10%, in another implementation within 5%, in another implementation within 1% and in another implementation within 0.5%. The term “coupled” as used herein is defined as connected, although not necessarily directly and not necessarily mechanically. A device or structure that is “configured” in a certain way is configured in at least that way but may also be configured in ways that are not listed.

1. A storage device to manage free super blocks when a number of empty super blocks is at a critical level, the storage device comprises:
a memory device including multiple dies divided into physical blocks; and
a controller to form super blocks from the physical blocks on the dies, store information for empty super blocks in a free pool, determine that the storage device has been initialized after a power failure and that a host write request has been received by the storage device after the initialization of the storage device, determine that the number of empty super blocks in the free pool is less than a warning threshold, obtain a first super block from the free pool, divide the first super block into a set of sub-super blocks, allocate one of the sub-super blocks for the host write request, determine that the storage device has been reinitialized after a successive power failure, and close an allocated sub-super block after the reinitialization of the storage device.

2. The storage device of claim 1, wherein the controller compares a critical threshold and the warning threshold with the number of empty super blocks in the free pool, wherein the critical threshold indicates a minimum number of empty super blocks in the free pool and the warning threshold indicates when the number of empty super blocks in the free pool is close to the critical threshold.

3. The storage device of claim 1, further comprising a recycle threshold that indicates a first number of empty super blocks to be buffered in the free pool to perform recycling operations and a steady-state threshold that indicates a second number of empty super blocks to be kept in the free pool for random workloads.

4. The storage device of claim 1, further comprising an internal memory to store a formed super block list including a first list of super block identifiers, each of which is associated with a super block, and an unformed super block list including a second list of super block identifiers, each of which is associated with a super block that is to be divided in sub-super blocks.

5. The storage device of claim 1, further comprising an internal memory to store a formed sub-super block list including a first list of sub-super block identifiers, each of which is associated with a formed sub-super block, and an unformed sub-super block list including a second list of sub-super block identifiers, each of which is associated with an unformed sub-super block.

6. The storage device of claim 5, wherein the unformed sub-super block list includes a predefined maximum number of sub-super blocks identifiers.

7. The storage device of claim 1, further comprising a mapping table to associate the first super block with the set of sub-super blocks.

8. The storage device of claim 7, wherein the set of sub-super blocks have consecutive identifiers and an entry in the mapping table includes a first super block identifier mapped to a sub-super block identifier for a first sub-super block in the set of sub-super blocks.

9. The storage device of claim 7, wherein an entry in the mapping table includes a valid page count of sub-super blocks in the set of sub-super blocks and a sparse pool index to be updated based on the valid page count.

10. The storage device of claim 9, wherein the sparse pool index indicates that a sub-super block is valid and is used to identify sub-super blocks during a recycling operation.

11. The storage device of claim 1, wherein an identifier for the first super block is added to a sparse pool, wherein placement of the first super block identifier in the sparse pool causes the first super block to be selected during a recycling operation.

12. The storage device of claim 1, wherein the controller reduces thresholds associated with the free pool when the controller divides the first super block.

13. A method for managing free super blocks in a storage device when a number of empty super blocks is at a critical level, the storage device comprises a controller to perform a method comprising:
forming super blocks and storing information for empty super blocks in a free pool;
determining that the storage device is initialized after a power failure;
receiving a write request and identifying a source of the write request after the initialization of the storage device;
identifying a client write request,
determining that a criterion for creating a set of sub-super blocks exists;
obtaining a first super block from the free pool and dividing the first super block into the set of sub-super blocks;
allocating one of the sub-super blocks for the client write request;
determining that the storage device has been reinitialized after a successive power failure; and
closing an allocated sub-super block after the reinitialization of the storage device.

14. The method of claim 13, wherein the criterion includes determining that a first number of empty super blocks in the free pool is less than a warning threshold and that a second number of formed sub-super blocks is less than a maximum number allowed.

15. The method of claim 13, further comprising closing super blocks that were opened prior to initialization of the storage device.

16. The method of claim 13, further comprising identifying a maintenance write request and processing the maintenance write request with a second super block from the free pool.

17. The method of claim 13, wherein dividing the first super block includes adding an identifier for the first super block to an unformed super block list.

18. The method of claim 13, wherein dividing the first super block includes assigning consecutive identifiers from an unformed sub-super block list to the set of sub-super blocks and moving the consecutive identifiers for the set of sub-super blocks from the unformed sub-super block list to a formed sub-super block list.

19. A method for recycling free super blocks in a storage device including super blocks and sub-super blocks, the storage device comprises a controller to perform a method comprising:
determining that a recycling operation is to be performed;
selecting a first super block for recycling, determining that the first super block is not mapped to a set of sub-super blocks in a mapping table, and performing garbage collection on the first super block; and
selecting a second super block for recycling, determining that the second super block is mapped to the set of sub-super blocks in the mapping table, performing garbage collection on the set of sub-super blocks, and reuniting the set of sub-super blocks to reform the second super block.

20. The method of claim 19, wherein reuniting comprises moving identifiers for the set of sub-super blocks from a formed sub-super block list to an unformed sub-super block list and removing an identifier for the second super block from an unformed super block list.
